(19) United States
(12) Patent Application Publication
(10) Pub. No.: US 2015/0355056 A1
(43) Pub. Date: Dec. 10, 2015

(54) LASER MEASUREMENT SYSTEM AND METHOD

(71) Applicant: CATERPILLAR INC., Peoria, IL (US)

(72) Inventors: KEVIN L. MARTIN, WASHBURN, IL (US); JASON JURA, PEORIA, IL (US)

(21) Appl. No.: 14/299,648

(22) Filed: Jun. 9, 2014

(51) Int. Cl. G01M 17/02; G01B 11/22; G01B 11/08

(52) U.S. Cl. CPC G01M 17/027; G01B 11/08; G01B 11/22

(57) ABSTRACT

A laser measurement system for tires is provided. The laser measurement system includes a rim mounting bracket including an arm. The laser measurement system includes a mounting head slidably coupled to the arm. The laser measurement system includes a laser coupled to the mounting head and configured to be positioned over at least one side surface of a tire that does not contact a ground surface when the tire is in use.

### TECHNICAL FIELD

This patent disclosure relates generally to measurement systems and methods for tires, and more particularly, to a laser measurement system and method for tires.

### BACKGROUND

Tires need to be measured in the field to determine wear rate. The diameter of a tire as well as tread depth needs to be measured easily. The diameter of a simple cylindrical tire can be measured with a tape measure, but tires often have cross sectional shapes that make them difficult to measure with a tape measure. The crown on the tread surface and complex shape of the sidewall can make it difficult to measure various dimensions of the tire with a conventional tape measure.

One conventional setup discussed in German Patent No. DE 102006007948 B3 discusses measurements on a surface of a tire making contact with a ground surface or a road using a laser emitter with a laser sensor. However, the '948 patent does not discuss how such a conventional setup can perform measurements of the side rim, inside pockets, or other parts of the tire that may be curved and non-cylindrical or irregular in shape.

Accordingly, there is a need to resolve these and other problems related to laser measurement systems and methods for tires.

### SUMMARY

In one aspect, a laser measurement system for tires is provided. The laser measurement system includes a rim mounting bracket including an arm. The laser measurement system includes a mounting head slidably coupled to the arm. The laser measurement system includes a laser coupled to the mounting head and configured to be positioned over at least one side surface of a tire that does not contact a ground surface when the tire is in use.

In another aspect, a laser measurement method is provided. The laser measurement method includes providing a rim mounting bracket including an arm. The laser measurement method includes providing a mounting head slidably coupled to the arm. The laser measurement method includes providing a laser coupled to the mounting head and configured to be positioned over at least one side surface of a tire, said at least one side surface not contacting a ground surface when the tire is in use. The laser measurement method includes performing a measurement associated with the at least one side surface using the laser.

In yet another aspect, a laser measurement system is provided. The laser measurement system includes a rim mounting bracket including an arm having a slot along a length of the arm. The laser measurement system includes a mounting head slidably coupled to the arm at the slot. The laser measurement system includes a laser coupled to the mounting head and configured to be positioned over at least one side surface of a tire to which the rim mounting bracket is attached, wherein said laser is arranged to slide over the at least one side surface and to take measurements, upon reaching an outer perimeter of the tire, the laser is configured to take additional measurements when positioned over at least one additional surface of the tire, said at least one additional surface being in contact with a ground surface when the tire is in use.

### BRIEF DESCRIPTION OF THE DRAWINGS

FIG. 1 illustrates a first view of a laser measurement system, in accordance with an aspect of this disclosure.

FIG. 2 illustrates a second view of the laser measurement system of FIG. 1, in accordance with an aspect of this disclosure.

FIG. 3 illustrates an example of the laser measurement system of FIG. 1 in use on an at least one side surface of a tire, in accordance with an aspect of this disclosure.

FIG. 4 illustrates another example of the laser measurement system of FIG. 1 in use on the at least one side surface of the tire, in accordance with an aspect of this disclosure.

FIG. 5 illustrates yet another example of the laser measurement system of FIG. 1 in use, this time on an at least one additional surface of the tire, in accordance with an aspect of this disclosure.

FIG. 6 illustrates a mounting head of the laser measurement system of FIG. 1, in accordance with an aspect of this disclosure.

FIG. 7 illustrates the mounting head of the laser measurement system of FIG. 1 with a laser and an additional light source placed alongside the laser, in accordance with an aspect of this disclosure.

FIG. 8 illustrates a top view of the mounting head, in accordance with an aspect of this disclosure.

FIG. 9 illustrates a measuring base of the laser measurement system of FIG. 1, in accordance with an aspect of this disclosure.

FIG. 10 illustrates a top view of the laser measurement system in use, in accordance with an aspect of this disclosure.

FIG. 11 presents a flowchart of a process or a method for laser based measurement system for tires, in accordance with an aspect of this disclosure.

FIG. 12 illustrates exemplary measurements that may be carried out using the laser measurement system, in accordance with an aspect of this disclosure.

### DETAILED DESCRIPTION

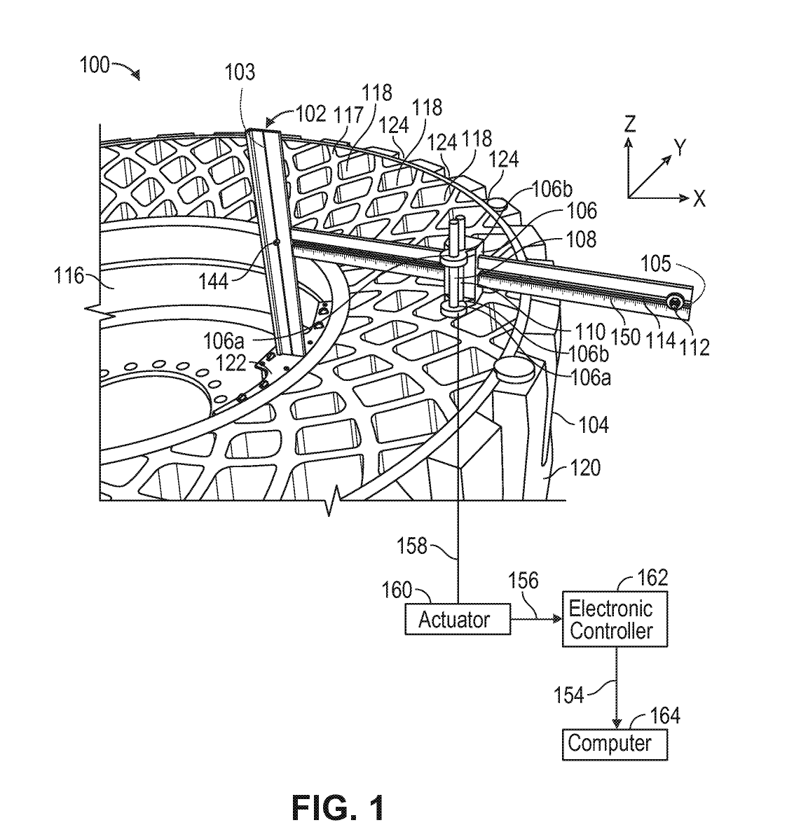

Now referring to the drawings, wherein like reference numbers refer to like elements, there is illustrated in FIG. 1 an exemplary aspect of a laser measurement system 100, in accordance with an aspect of this disclosure. In one aspect, the laser measurement system 100 includes a rim mounting bracket 102, a tire 104, a mounting head 106, a laser 108, at least one additional light source 110, a bolt 112, and a measuring base 122. In one aspect, the laser measurement system 100 may include an actuator 160, an electronic controller 162, and a computer 164. The rim mounting bracket 102 is coupled to a rim 116 of the tire 104 via the measuring base 122. The mounting head 106 is coupled to the rim mounting bracket 102 at an arm 105 of the rim mounting bracket 102. The laser 108 and the at least one additional light source 110 are held in place by the mounting head 106. The bolt 112 is provided at an end of the arm 105, the end of the arm 105 that has the bolt 112 being away from a vertical member 103 of the rim mounting bracket 102. The arm 105 is coupled to the vertical member 103 at another end of the arm 105, e.g., by a screw 144. The arm 105 and the vertical member 103 are arranged to be in a relative perpendicular arrangement, although other relative angular orientations of the arm 105 and the vertical member 103 may be used. The vertical member 103 may be coupled to the measuring base 122 to secure the rim mounting bracket 102 to the tire 104 at the rim 116 of the tire 104. The actuator 160 may be coupled to the mounting head 106 via a connector 158. The actuator 160 may be further coupled to the electronic controller 162 via a connection 156. The electronic controller 162 may be coupled to the computer 164 via a bus 154. It is to be noted that the relative orientation of the various components of the laser measurement system 100 are by way of example only and not by way of limitation, as other arrangements and orientations may be contemplated by one of ordinary skill in the art in view of this disclosure.

In one aspect, the rim mounting bracket 102 may be substantially in a shape of a T-square. The rim mounting bracket 102 may be made of a rigid material (e.g., metal, wood, and the like, or combinations thereof). The arm 105 may be of dimensions suitable to accommodate the mounting head 106 such that the mounting head 106 may slide along or slidably move along a length of the arm 105 between the end where the bolt 112 is located and the other end where the arm 105 is coupled to the vertical member 103. The arm 105 may have a cutout slit 114 along which the mounting head 106 may roll. Such rolling of the mounting head 106 may be accomplished by attaching rollers (not shown) to the mounting head 106, which rollers also fit into the cutout slit 114. In one aspect, the arm 105 may have markings 150 to indicate a distance moved by the mounting head 106 along a length of the arm 105. The distance moved may be an indication of a dimension of the tire 104 laid on an XY-plane. The markings 150 may be calibrated such that the readings on the markings 150 correspond to one or more positions of the laser 108 above or over the tire 104. The markings 150 may be in standard measurement units, e.g., millimeters (mm). It is to be noted that in addition to or instead of the markings 150, the laser measurement system 100 may include position sensors (not shown) to detect the distance moved by the mounting head 106. The mounting head 106 may be prevented by the bolt 112 to slide off the arm 105.

In one aspect, the tire 104 may be a non-pneumatic tire. Alternatively, the tire 104 may be a pneumatic tire. By way of example only and not by way of limitation, the tire 104 may be a tire used for a mobile or a stationary machine that performs operations associated with industries such as mining, automotive, aerospace, naval, power generation, clean energy, construction, farming, transportation, landscaping, or the like. Such a machine in which the tire 104 may be used may be a medium wheel loader, a large wheel loader, a medium track-type tractor, a large track-type tractor, an off-highway truck, a large mining truck, a wheel tractor scraper, a motor grader, an articulated truck, a hydraulic excavator, an electric rope shovel, a dragline, an industrial/waste machine, a vehicle, an earth-moving machine, a wind turbine, an airplane engine, a ship, a submarine, a space craft, a bridge or a civil structure, or subcomponents thereof. In use, the tire 104 and/or a part thereof may undergo wear and tear due to contact with a ground surface. The ground surface may be rough, smooth, paved, or mixed terrain type. The tire 104 may include at least one side surface 117 and at least one additional surface 120. In use, the tire 104 may roll on the at least one additional surface 120 that is in contact with the ground surface. A weight of the machine in which the tire 104 is being used may then at least partially bear upon the at least one additional surface 120 and cause wear and tear or deformation of the at least one additional surface 120. Such a deformation may be temporary or it may be permanent. For example, at a point of contact with the ground surface, the at least one additional surface 120 may flatten or reduce in diameter. Due to the weight of the machine in which the tire 104 is being used, or due to its own weight, the at least one side surface 117 may also deform or bend. Such deformation or bending of the at least one side surface 117 may be in the form of compressions in the shape and structure of the at least one side surface 117. Various aspects of this disclosure may be used to determine such wear and tear and/or bending or deformation of the tire 104, as discussed herein.

The at least one side surface 117 includes a plurality of pockets 118. The pockets 118 may be hollow, i.e., filled with air, or may be filled with an elastic/gelatinous material, depending on the specific applications for which the tire 104 is used. At production or after manufacturing of the tire 104, the at least one side surface 117 including the plurality of pockets 118 have an initial dimension (height, depth, thickness, etc.). The plurality of pockets 118 may be of equal dimensions. Alternatively, the plurality of pockets 118 may be of different dimensions. For example, the plurality of pockets 118 may be distributed such that the largest pockets in the plurality of pockets 118 are near the at least one additional surface 120 and the smallest pockets in the plurality of pockets 118 are near the rim 116. Other regular or irregular distributions of the plurality of pockets 118 may exist. For example, only a part of the at least one side surface 117 may include the plurality of pockets 118 and the remaining part may be solid material. Likewise, the at least one side surface 117 may have groups of the plurality of pockets 118 interspersed with solid tire material inside the at least one side surface 117. The at least one side surface 117 may have an irregular or asymmetric surface geometry. In one aspect, the at least one side surface 117 may be curved (convex or concave) making it difficult to measure various dimensions thereof using a tape measure or other conventional measuring techniques. During use of the tire 104, e.g., in the field, dimensions of the plurality of pockets 118 change or get distorted over a period of time. For example, the at least one side surface 117 may compress causing the overall shape and functionality of the tire 104 to deviate from an original intended shape or functionality at a time of production of the tire 104. Various aspects of this disclosure may be used to determine such wear and tear and/or bending or deformation of the tire 104, including changes to the dimensions of the at least one side surface 117 in a fast and efficient manner.

The at least one additional surface 120 may include a plurality of treads 124. The treads 124 may be located continuously on the at least one additional surface 120 and/or may be located at regular intervals. The treads 124 may be of a suitable shape and dimensions at the time of production of the tire 104. Similar to the at least one side surface 117, the at least one additional surface 120 including the treads 124 may reduce in thickness, undergo changes from its original dimensions, or may suffer from damage (punctures, cracking, etc.). Further, a shape of the at least one additional surface 120 may be curved or of irregular or asymmetric geometry, also making it difficult to measure various dimensions thereof using a tape measure or other conventional measuring techniques. Various aspects of this disclosure may be used to determine such wear and tear and/or bending or deformation of the tire 104, including changes to the dimensions of the at least one additional surface 120 in a fast and efficient manner.

The tire 104 may include the rim 116 attached to an inner surface (not shown). The rim 116 may be metallic or made of a rigid hard material. The rim 116 is configured to attach to an inner diameter of the tire 104 and aids in preserving an original shape of the tire 104. Further, the rim 116 provides a surface where the measuring base 122 may be attached to set up the rim mounting bracket 102 of the laser measurement system 100. Furthermore, the rim 116 may provide couplings (not shown) configured to couple the tire 104 to a machine (not shown) in which the tire 104 may be used. In one aspect, without the rim 116, the tire 104 may collapse upon itself or may be unusable in a machine. Further, the tire 104 may have surfaces in addition to those illustrated in FIGS. 1-9, which surfaces are hidden from view in FIGS. 1-9.

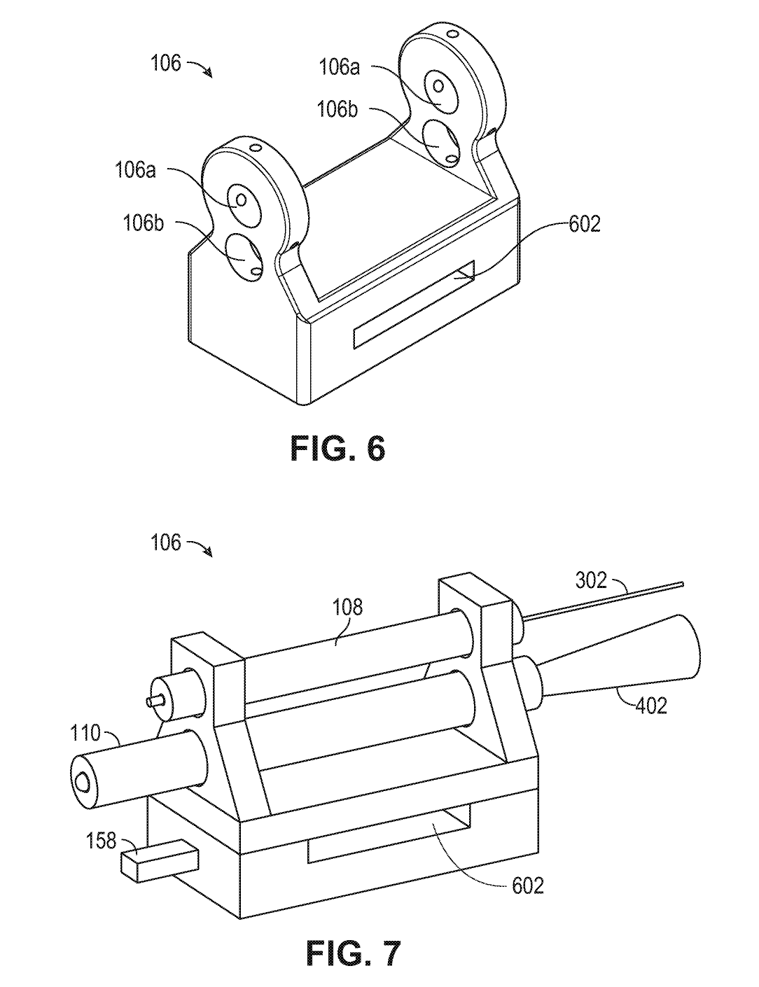

In one aspect, the mounting head 106 includes a first receptacle 106a to hold the laser 108. Additionally or optionally, the mounting head 106 may include a second receptacle 106b to hold the at least one additional light source 110. The mounting head 106 may be made of a rigid hard material. FIG. 6 illustrates the first receptacle 106a and the second receptacle 106b with the laser 108 and the at least one additional light source 110 removed, respectively. Additionally or optionally, the mounting head 106 may include a slot 602 into which the arm 105 may be inserted. Upon insertion of the arm 105, the mounting head 106 may then slidably move along the arm 105. Likewise, FIG. 7 illustrates the mounting head 106 with the laser 108 and the at least one additional light source 110 placed alongside the laser 108. It is to be noted that the relative positioning of the laser 108 and the at least one additional light source 110 is by way of example only and not by way of limitation. For example, in one aspect, the positioning of the laser 108 and the at least one additional light source 110 may be interchanged. Further, the mounting head 106 may include more than one of the at least one additional light source 110. For example, the laser 108 may be surrounded by a plurality of light sources similar to the at least one additional light source 110 placed in respective receptacles. In one aspect, as illustrated in FIG. 7, the mounting head 106 may include the connector 158 to couple to the actuator 160. In one aspect, the mounting head 106 may be coupled to the arm 105 such that the laser 108 and/or the at least one additional light source 110 may be rotated to be positioned to a desired spot. Further, additional degrees of rotation may be performed by rotating the arm 105 about the screw 144.

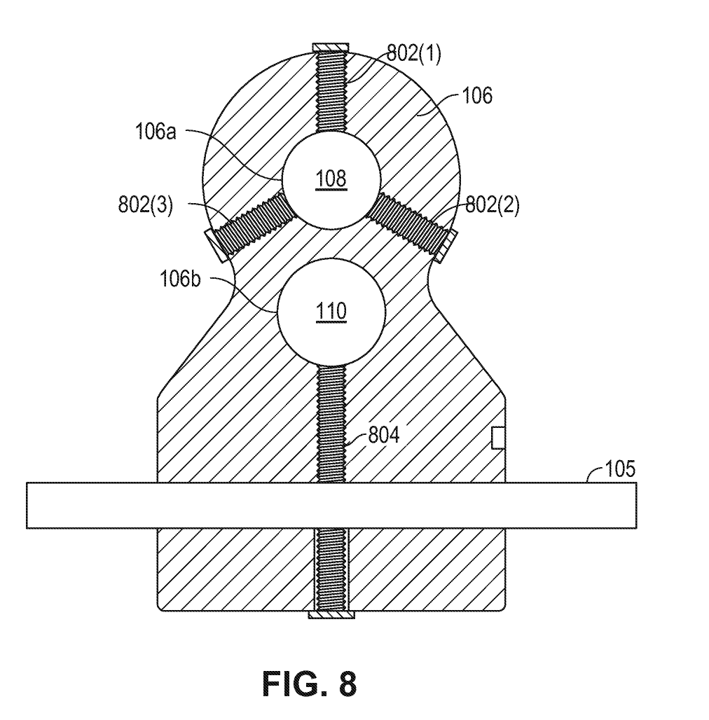

FIG. 8 illustrates the mounting head 106 coupled to the arm 105 when viewed from the top (“plan view”), in accordance with an aspect of this disclosure. The mounting head 106 may be interchangeably referred to as a measuring head. In one aspect, the mounting head 106 may include a set of screws 802(1)-802(3) to aim the laser 108 to an appropriate spot on the at least one side surface 117 and/or the at least one additional surface 120. Although, only three screws 802(1)-802(3) are illustrated, higher or lower number of screws may be used. Likewise, the mounting head 106 includes at least one additional screw 804 to hold the at least one additional light source 110 securely and to adjust a position or aim of the at least one additional light source 110.

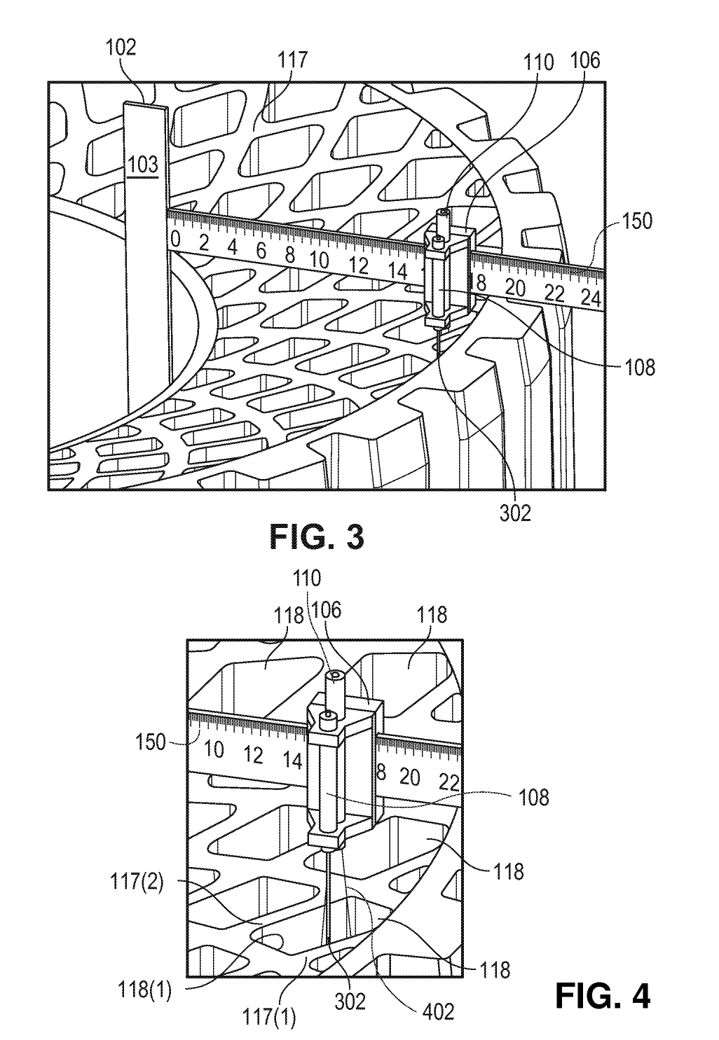

The laser 108 may be oriented to point a laser beam 302 (shown in FIG. 3, for example) toward or on the at least one side surface 117 and/or the at least one additional surface 120 of the tire 104. The laser beam 302 may be reflected back and captured by a camera or other sensor to reveal a feature of a surface of the plurality of pockets 118 and/or the treads 124, for example. The at least one additional light source 110 may output a light beam 402 (shown in FIG. 4, for example) to illuminate a region around where the laser beam 302 is incident on the surface of the plurality of pockets 118 and/or the treads 124. By way of example only and not by way of limitation, the laser 108 may be a standard eye safe on/off type laser emitting green wavelength and 5 mW power output, although other types of lasers with other wavelengths could be used. Likewise, by way of example only and not by way of limitation, the at least one additional light source 110 may be a penlight such as a disposable plastic cover penlight, an ultra-violet inspection penlight, a flashlight, or the like, or combinations thereof.

The actuator 160 may be a piezoelectric actuator, a mechanical spring based actuator, a micro-hydraulic actuator, an electro-magnetic actuator, a motor, and the like. The actuator 160 is configured to move the mounting head 106 along the arm 105 based upon signals received from the electronic controller 162. The actuator 160 may be configured to move the mounting head 106 in a continuous motion or in a discrete stepper type motion. In one aspect, the actuator 160 may be optional and the mounting head 106 may be moved along the arm 105 manually.

The electronic controller 162 may be an integrated chip (IC) or other circuit configured to generate and provide signals to activate the actuator 160. Such signals may be controlled by software on the computer 164 to which the electronic controller 162 is coupled. In one aspect, the electronic controller 162 may include a processor configured to generate the signals that control the actuator 160.

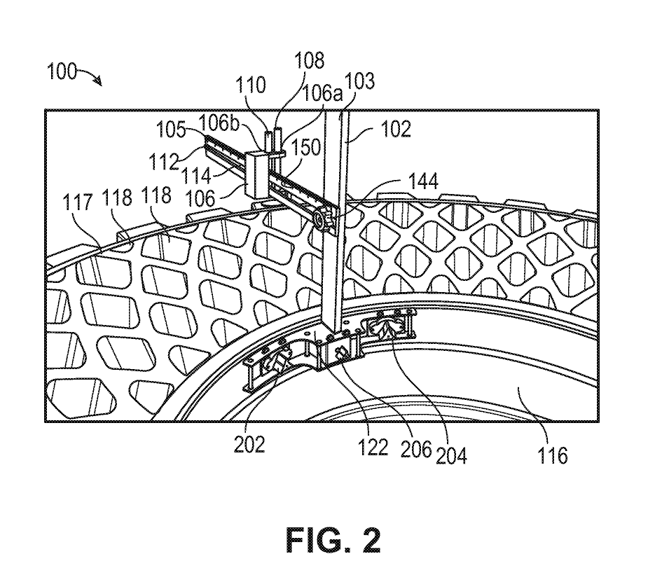

Referring to FIG. 2, another view of the laser measurement system 100 is illustrated, in accordance with an aspect of this disclosure. FIG. 2 illustrates the measuring base 122 coupled to the rim 116. The measuring base 122 is coupled to the rim 116 via a pair of attachment devices 202 and 204. In one aspect, the pair of attachment devices 202 and 204 may be two ON/OFF magnets or a pair of clamps, although other types of clamping or attachment arrangements, e.g., latches, could be used. The pair of attachment devices 202 and 204 are configured to couple the rim mounting bracket 102 removably to the rim 116. For example, the pair of attachment devices 202 and 204 may be quickly released to free the tire 104 and the laser measurement system 100 may then be used on some other tire. In one aspect, the measuring base 122 includes a knob 206 to tighten the rim mounting bracket 102 to the measuring base 122.

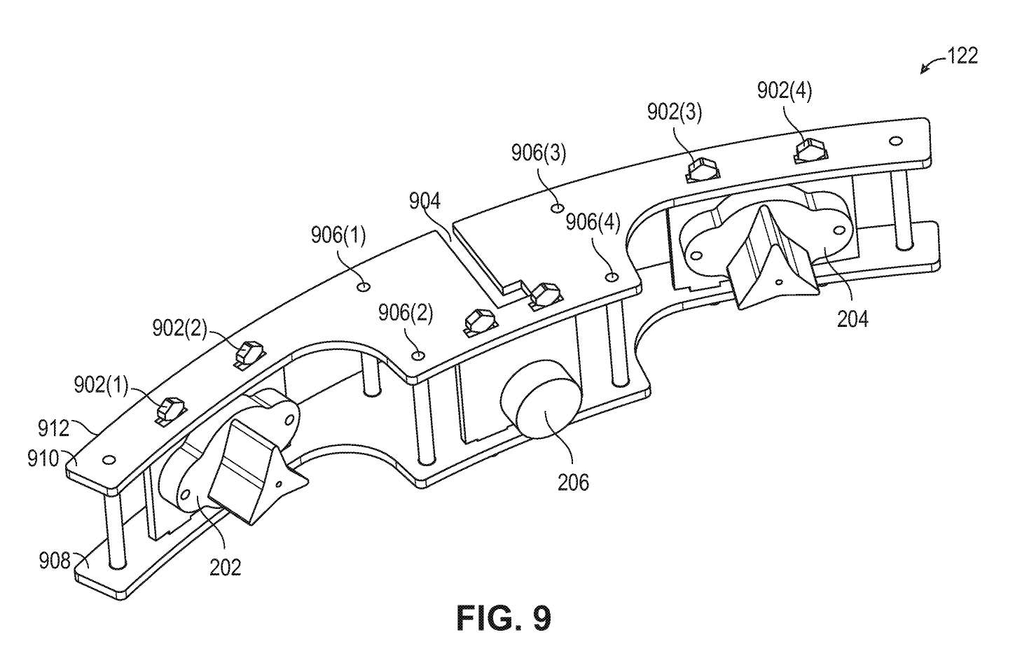

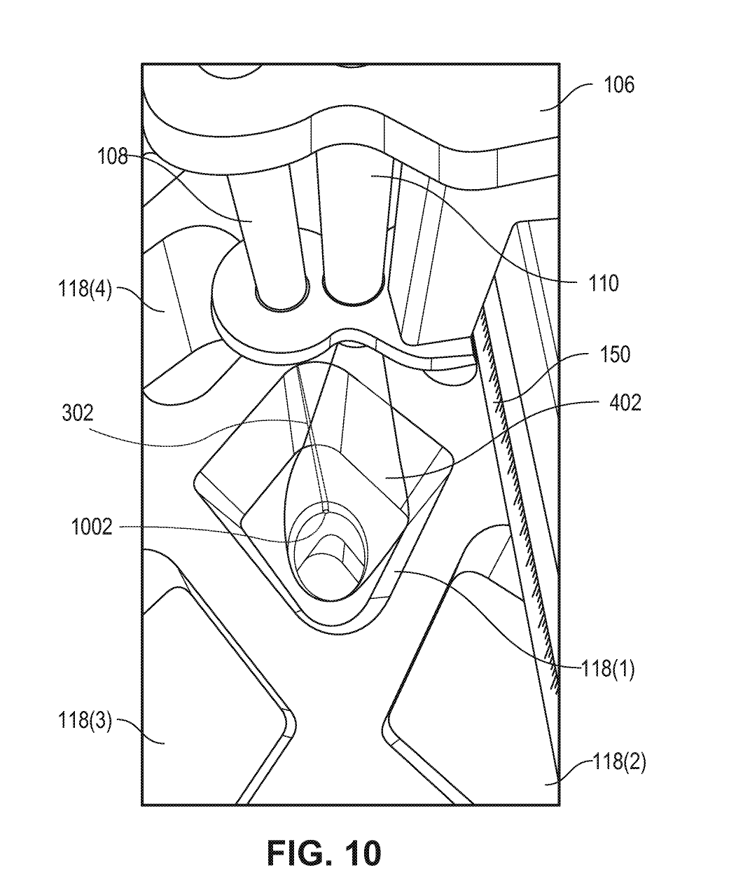

FIG. 9 illustrates the measuring base 122, in accordance with an aspect of this disclosure. In one aspect, the measuring base 122 includes a plurality of twist tabs 902(1)-902(4), a bracket slot 904, a plurality of standoffs 906(1)-906(4) that separate a pair of plates 908 and 910. It is to be noted that the number of the plurality of twist tabs 902(1)-902(4) and the plurality of standoffs 906(1)-906(4) may be variable, and the number of the plurality of twist tabs 902(1)-902(4) and the plurality of standoffs 906(1)-906(4) shown in FIG. 9 is by way of example only and not by way of limitation. The bracket slot 904 is dimensioned to accommodate the vertical member 103 of the rim mounting bracket 102. The pair of plates 908 and 910 have a curvature 912 that matches a curvature of the rim 116 for easy attachment. The plurality of twist tabs 902(1)-902(4) are used to get a tight fit-up of the measuring base 122 without welding to the rim 116, which may cause additional distortion of the tire 104. The plurality of standoffs 906(1)-906(4) are used to provide stiffness to the structure of the measuring base 122. In one aspect, the plurality of standoffs 906(1)-906(4) may be bolts.

FIG. 3 illustrates an example of the laser measurement system 100 in use on the at least one side surface 117, in accordance with an aspect of this disclosure. The markings 150 on the arm 105 may be calibrated such that when the laser beam 302 is incident on an exemplary spot on the at least one side surface 117, the reading on the markings 150 correspond to a measurement of a dimension of the at least one side surface 117, e.g., a depth of the plurality of pockets 118. The laser 108 may be aimed on or positioned over multiple such spots. Each such position of the laser 108 corresponds to a reading on the markings 150. A difference between such readings may indicate a change in the dimensions of the at least one side surface 117. The differences in the readings inferred from the markings 150 may indicate whether the tire 104 has undergone compressions during use. For example, a first position of the laser 108 may read 18 mm on the markings 150 and a second position may read 16.8 mm. Originally, when the tire 104 was manufactured, the actual readings for these two positions of the laser 108 may differ exactly by 1 mm, as compared to 1.2 mm. This difference of 0.2 mm may indicate compression in the shape of the plurality of pockets 118.

FIG. 4 illustrates another aspect of this disclosure where the laser measurement system 100 is in use on the at least one side surface 117, specifically, for a pocket 118(1) of the plurality of pockets 118, although other pockets in the plurality of pockets 118 could be used. Since each of the plurality of pockets 118 has a depth and to precisely point the laser beam 302, the light beam 402 may be outputted by the at least one additional light source 110 to illuminate a region surrounding a spot around where the laser beam 302 is incident in an inside surface of the pocket 118(1). The laser 108 may be positioned at different points inside the pocket 118(1) and at each such point a reading from the markings 150 may be recorded, e.g., by the computer 164 in a memory thereof, or manually. For example, a first position of the laser 108 may point the laser beam 302 at a first wall 117(1) of the pocket 118(1). A second position of the laser 108 may point the laser beam 302 at a second wall 117(2) of the pocket 118(1). A difference between the readings at the first position and at the second position obtained from the markings 150 may indicate whether the pocket 118(1) has undergone a change in shape from an original shape at production of the tire 104. Likewise, intermediate and/or additional positions of the laser 108 may be used to measure other dimensions on the at least one side surface 117 and/or inside one or more of the plurality of pockets 118. The laser 108 may be positioned at such positions over the at least one side surface 117 and/or the at least one additional surface 120 by the actuator 160 or manually by a technician or user.

FIG. 10 illustrates a top view of the laser measurement system 100 in use, in accordance with an aspect of this disclosure. FIG. 10 illustrates the laser 108 being pointed to a spot 1002 inside the pocket 118(1). The light beam 402 surrounds the spot 1002, and makes a surface inside the pocket 118(1) clearly visible for inspection and/or measurement. The spot 1002 may be moved inside the pocket 118(1) and corresponding measurements may be read on the markings 150. In one aspect, when the tire 104 is painted black in color, the internal surfaces of the plurality of pockets 118 may be too dark to be inspected directly by the human eye. The spot 1002 may be used to illuminate such dark regions of the plurality of pockets 118. FIG. 10 further illustrates additional pockets 118(2)-118(4) by way of example only.

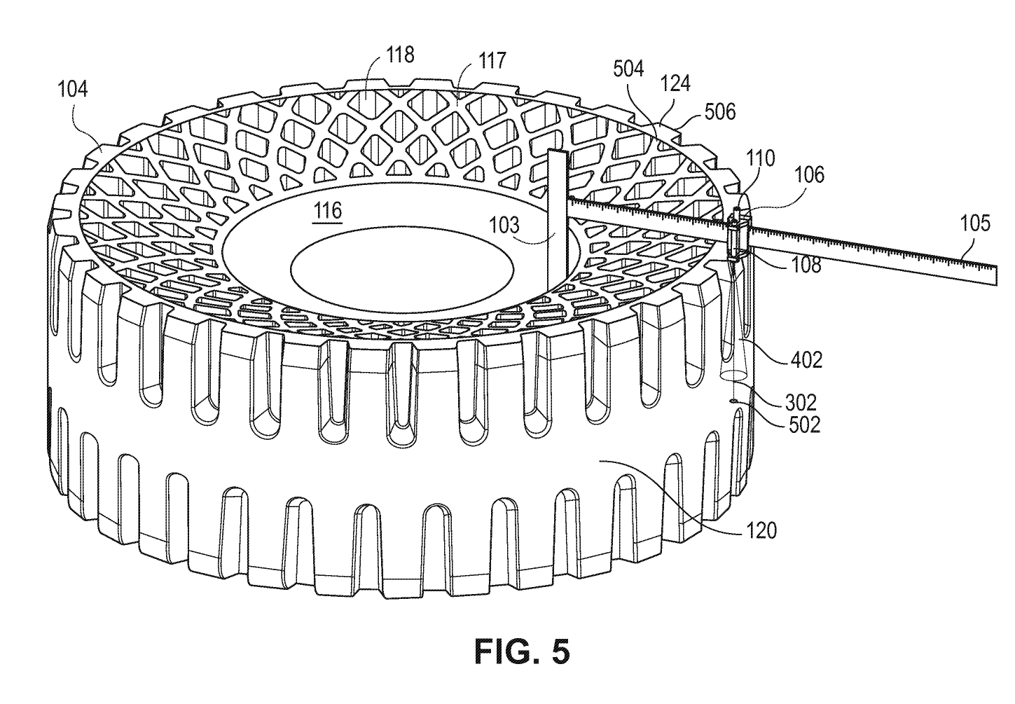

FIG. 5 illustrates yet another example of the laser measurement system 100 in use, this time on the at least one additional surface 120, in accordance with an aspect of this disclosure. The at least one additional surface 120 has the treads 124 and contacts the ground surface in use. As a result, there is wear and tear for the tire 104. Such wear and tear may reflect in altered dimensions of various parts of the tire 104, e.g., in changed depth of the treads 124 or in a changed thickness of the at least one additional surface 120. The laser beam 302 may be pointed at a spot 502 on the at least one additional surface 120. A reading corresponding to the diametric thickness of the tire 104 may be obtained by the position of the laser 108 indicated on the markings 150. Likewise, a difference between an outer perimeter 506 and an inner perimeter 504 may indicate how much the treads 124 have worn off due to use of the tire 104. Additional readings corresponding to additional spots on the at least one additional surface 120 may be taken to estimate or determine an overall wear of the tire 104.

### INDUSTRIAL APPLICABILITY

An aspect of the present disclosure is applicable generally to tires and measurement systems therefor, and more particularly, to a laser measurement system for tires. Conventional techniques for measuring wear and tear or change in dimensions of tires rely on simple manual tape measurement systems and methods. Such tape measure fails when the tire has curved surfaces, e.g., in non-pneumatic tires. Further, such tape measures are inaccurate. No conventional system exists that also measures compressions/expansions/distortions of inside pockets of the tire, in addition to a diameter change of a surface of the tire that touches the ground. The aspects of the present disclosure overcome these drawbacks.

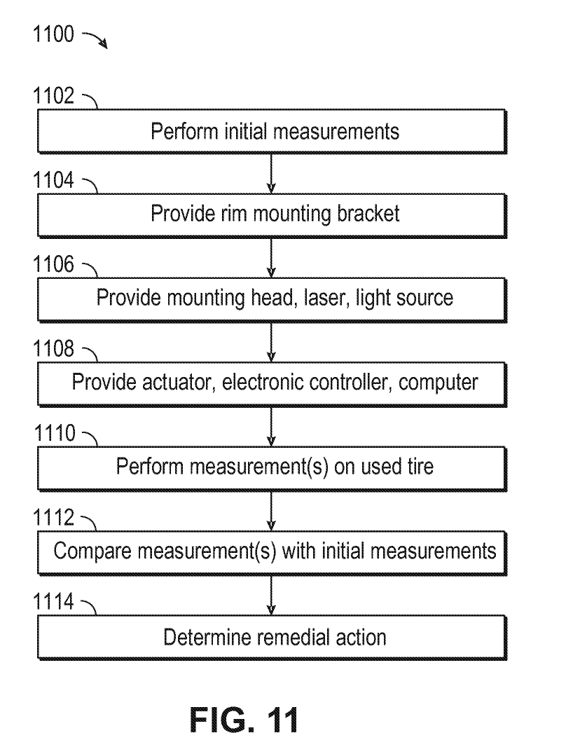

FIG. 11 presents a flowchart of a process or a method 1100 for laser based measurement system for tires, in accordance with an aspect of this disclosure. One or more processes of the method 1100 of may be skipped or combined as a single process, repeated several times, and the flow of operations in the method 1100 may be in any order not limited by the specific order illustrated in FIG. 11. For example, various operations may be moved around in terms of their respective orders, or may be carried out in parallel with one or more other operations. Further, the functioning or functionalities of the laser measurement system 100 are not affected by an order in which the aspects discussed in FIGS. 1-10 are implemented, and such an order of implementation is by way of example only and not by way of limitation.

The method 1100 may begin in an operation 1102 where initial measurements may be performed on the tire 104. Such initial measurements may be performed at a time of production of the tire 104 or immediately thereafter prior to a first use of the tire 104. Such initial measurements are then stored, for example, in a memory of the computer 164 for comparison later on. The initial measurements may include parameters such as tread depth, diameter of the tire 104, depths of the plurality of pockets 118, thickness of the first wall 117(1) and/or the second wall 117(2), etc.

In an operation 1104, the rim mounting bracket 102 is provided. The rim mounting bracket 102 may be attached to the rim 116 via the measuring base 122. For example, the measuring base 122 may be attached to the rim 116 via the pair of attachment devices 202 and 204, and tightened using the knob 206. In one aspect, the rim mounting bracket 102 may be removably attached to the tire 104 at the rim 116.

In an operation 1106, the mounting head 106 is provided. The mounting head 106 may be provided with the laser 108 and the at least one additional light source 110 already attached to the mounting head 106. Alternatively, the mounting head 106 may be provided for attachment to the arm 105 without the laser 108 and the at least one additional light source 110. The laser 108 and the at least one additional light source 110 may then be inserted into the first receptacle 106a and the second receptacle 106b, respectively. The mounting head 106 may be provided to couple to the arm 105 in a sliding manner, for example, at the cutout slit 114 in the arm 105.

In an operation 1108, the actuator 160, the electronic controller 162, and the computer 164 may be provided. The actuator 160 may be provided to couple to the mounting head 106. The actuator 160 may move the mounting head 106 and hence move the laser 108 and the at least one additional light source 110. In one aspect, the operation 1108 may be optional. For example, as and when the readings corresponding to positions of the laser beam 302 on the tire 104 are taken visually from the markings 150, the laser 108 may be moved manually by a technician or user of the laser measurement system 100. In one aspect, the actuator 160 may be provided close to the mounting head 106, and when activated by the electronic controller 162, may move the mounting head 106 along the arm 105.

In an operation 1110, additional measurements corresponding to changes in the dimensions of the tire 104 may be performed. For example, measurements in changes in the dimensions of the plurality of pockets 118 may be performed. In one aspect, measurements to the changes in the depth of the treads 124 may be performed. In yet another aspect, measurements in the changes to an outer diameter or a difference between the outer perimeter 506 and the inner perimeter 504 of the at least one additional surface 120 may be performed. The measurements may be performed by positioning the laser 108 over a plurality of spots on different areas of the tire 104, e.g., on the at least one side surface 117 and the at least one additional surface 120. The reading corresponding to each such position may then be read from the markings 150. In one aspect, such readings may be stored on the computer 164, e.g., in a memory of the computer 164.

In an operation 1112, the measurements performed in the operation 1110 may be compared with the original measurements of the tire 104 carried out in the operation 1102. For example, such a comparison may include statistical deviation computations. The compressions may be determined by the differences between the original measurements and the measurements carried out in the operation 1110. In one aspect, the comparison may be carried out by the computer 164. Alternatively, the comparison may be carried out manually, visually, or both.

In an operation 1114, based upon the comparison carried out in the operation 1112, one or more remedial operations or actions may be determined or carried out. For example, the computer 164 may determine that the tire 104 has sufficient wear and tear to qualify for retirement or discarding. Likewise, the computer 164 or the technician using the laser measurement system 100 may determine that some parts of the tire 104 may be repaired, predict remaining usable life of the tire 104, etc.

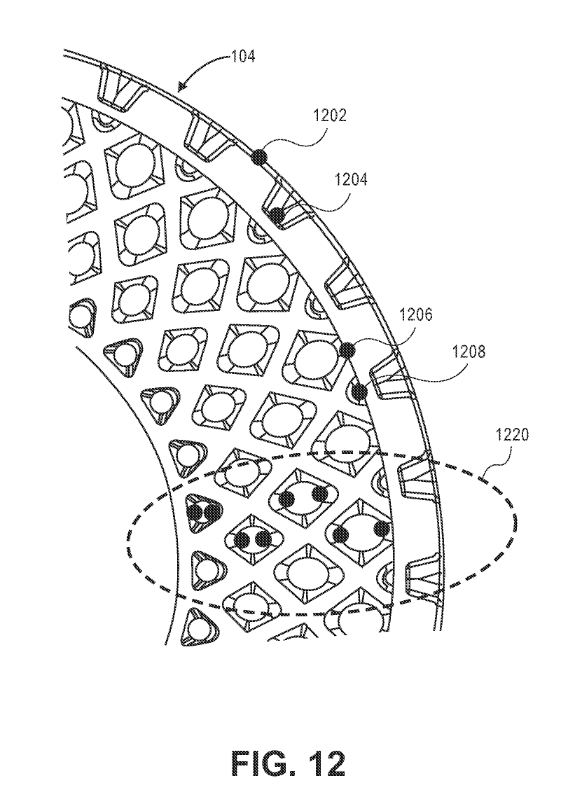

FIG. 12 illustrates exemplary measurements that may be carried out using the laser measurement system 100, in accordance with an aspect of this disclosure. In one aspect, a measurement at a spot 1202 of the laser beam 302 (not shown in FIG. 12) when the tire 104 is new may be a baseline dimension or an initial measurement. Several measurements at various places on an outer diameter or the outer perimeter 506 of the tire 104 may be used to measure a concentricity (roundness) of the tire 104 at the time of manufacture. A difference between the positions of the spot 1202 and a spot 1204 may be recorded as a tread depth of one or more of the plurality of treads 124, for example, by the computer 164 or manually by a technician. Since both surfaces at which the spot 1202 and the spot 1204, are respectively incident may wear, a measurement to obtain a difference between the spot 1202 and a spot 1206 may be performed using the laser measurement system 100 to determine a rate of tread wear for the plurality of treads 124. In one aspect, measurements relative to the spot 1206 may be performed so that the compression data set obtained for compression of the tire 104 does not get measured as tread wear. A diameter at a location of the spot 1206 may change due to compression set, and not due to tread wear of the plurality of treads 124. The tire 104 may take on a plastic set when loaded for the first few times, and any time a higher maximum load is applied. A diameter of the tire 104 at the spot 1206 may gradually go down, but stabilizes. Any wear measurements before such stabilization are then relative to the spot 1206. Likewise, a measurement may be made at a spot 1208 as an independent measurement or relative to the spot 1206. Measurements in a zone of spots 1220 and at various other places on the tire 104 may be taken for development purposes to see where compression set is taking place in the tire 104.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

1. A laser measurement system for tires, comprising:
a rim mounting bracket including an arm;
a mounting head slidably coupled to the arm; and
a laser coupled to the mounting head and configured to be positioned over at least one side surface of a tire that does not contact a ground surface when the tire is in use.

2. The laser measurement system of claim 1 further comprising:
at least one additional light source coupled to the mounting head alongside the laser and configured to provide a light beam around where a laser beam outputted by the laser is incident on the at least one side surface.

3. The laser measurement system of claim 2, wherein the mounting head is configured to include at least two receptacles for holding the laser and the at least one additional light source, respectively.

4. The laser measurement system of claim 1, wherein the at least one side surface is configured to be of irregular geometry and configured to include at least one pocket, the laser configured to be positioned over the at least one pocket to perform a measurement.

5. The laser measurement system of claim 1, wherein the laser is configured to be positioned over at least one additional surface of the tire, said at least one additional surface configured to be in contact with the ground surface when the tire is in use.

6. The laser measurement system of claim 1, wherein the rim mounting bracket is configured to include a measuring base with a pair of attachment devices, said measuring base being configured to be attached to a rim of the tire via the pair of attachment devices.

7. The laser measurement system of claim 6, wherein the pair of attachment devices are magnetic.

8. The laser measurement system of claim 1 further comprising:
an actuator coupled to the mounting head; and
an electronic controller configured to control the actuator to move the mounting head to a position where a measurement is to be taken.

9. The laser measurement system of claim 1, wherein an end of the arm includes a bolt arranged to prevent the mounting head from sliding off the arm.

10. The laser measurement system of claim 1, wherein the mounting head includes a set of screws configured to adjust an aim of the laser and at least one additional screw configured to secure an at least one additional light source.

11. A laser measurement method, comprising:
providing a rim mounting bracket including an arm;
providing a mounting head slidably coupled to the arm;
providing a laser coupled to the mounting head and configured to be positioned over at least one side surface of a tire, said at least one side surface not contacting a ground surface when the tire is in use; and
performing a measurement associated with the at least one side surface using the laser.

12. The laser measurement method of claim 11 further comprising:
comparing the performed measurement with an initial measurement value carried out during a production of the tire; and
performing a remedial operation on the tire based upon said comparing.

13. The laser measurement method of claim 11, wherein said performing the measurement includes measuring dimensions of a plurality of pockets in the at least one side surface of the tire.

14. The laser measurement method of claim 11, wherein said performing the measurement includes positioning the laser over at least one additional surface of the tire, said at least one additional surface being in contact with the ground surface when the tire is in use.

15. The laser measurement method of claim 11 further comprising:
providing at least one additional light source coupled to the mounting head alongside the laser for providing a light beam around where a laser beam outputted by the laser is incident on the at least one side surface.

16. The laser measurement method of claim 15, wherein providing the mounting head includes providing at least two receptacles for holding the laser and the at least one additional light source, respectively.

17. The laser measurement method of claim 11, wherein providing the rim mounting bracket includes providing a measuring base with a pair of attachment devices, said measuring base being attached to a rim of the tire via the pair of attachment devices.

18. The laser measurement method of claim 11 further comprising:
providing an actuator coupled to the mounting head; and
providing an electronic controller configured to control the actuator for moving the mounting head to a position where the measurement is to be taken.

19. The laser measurement method of claim 11, wherein an end of the arm includes a bolt arranged to prevent the mounting head from sliding off the arm.

20. A laser measurement system, comprising:
a rim mounting bracket including an arm having a slot along a length of the arm;
a mounting head slidably coupled to the arm at the slot; and
a laser coupled to the mounting head and configured to be positioned over at least one side surface of a tire to which the rim mounting bracket is attached, wherein said laser is arranged to slide over the at least one side surface and to take measurements, upon reaching an outer perimeter of the tire, the laser is configured to take additional measurements when positioned over at least one additional surface of the tire, said at least one additional surface being in contact with a ground surface when the tire is in use.
